(19) United States
(12) Patent Application Publication
(10) Pub. No.: US 2009/0224429 A1
(43) Pub. Date: Sep. 10, 2009

(54) Method of Making a Ball Chain

(76) Inventor: Chang-Hsin KUO, Taichung (TW)

Correspondence Address: Dr. BANGER SHIA, 102 Lindencrest Ct., Sugar Land, TX, 77479-5201, US

(21) Appl. No.: 12/467,105

(22) Filed: May 15, 2009

Related U.S. Application Data
(63) Continuation of application No. 11/372,870, filed on Mar. 10, 2006, now abandoned.

(51) Int. Cl. B29C 45/00

(52) U.S. Cl. 264/328.8

(57) ABSTRACT

Since all points on a spherical surface are equidistant from the center of its sphere, the occurrence of interference during mold release can be prevented by releasing the half sphere along the normal direction of a plane passing through the center of the sphere. In this invention, the upper and lower molds of the ball chain each has a protruding configuration having a spherical surface, and the upper and lower molds are released along an inclined direction, thus preventing the interference between the protruding configuration and the finished product during mold release. Such mold releasing method also can solve the difficulties in production and can improve the effect of the spacers for separating the steel balls.

This application is a continuation of part of U.S. patent application Ser. No. 11/372,870, which claims the benefit of the earlier filing date of Mar. 10, 2006. Claim 1 of this application is revised from claim 1 of the U.S. patent application Ser. No. 11/372,870, claims 2, 4-14 of this application are the previous claims 3-14 of the U.S. patent application Ser. No. 11/372,870, respectively, and claims 3 and 15 of the application is new.

### FIELD OF THE INVENTION

The present invention relates to a ball chain that is used in a rolling mechanism for preventing the steel balls from colliding with each other, and more particularly to a method for making such a ball chain.

### DESCRIPTION OF THE PRIOR ART

FIG. 1 is a front view of showing a conventional ball chain, FIG. 2 is a cross sectional view of the ball chain taken along the line A-A′ of FIG. 1. The ball chain 1 comprises a plurality of spacers 11, and a connecting member 12 is connected at either side of the spacers 11, so that the spacers 11 are connected in a string. Each two neighboring spacers 11 define a space for holding a steel ball 2, and each spacer 11 defines a concave 111, 112 in either side thereof for mating with the steel ball 2, so that a plurality of steel balls 2 can freely roll within the spaces defined by the spacers 11 without impacting each other. A ball chain is generally designed to have tens of spacers 11, and the spacers 11 are connected in a string by the ball chain. For easy description, however, only four spacers 11 are illustrated in the figures. The ball chain manufactured by the method may comprise three or four or more spacers 11, and the method of making it is the same.

A conventional method of making a ball chain is to use a plurality of steel ball as a core in an injection molding process, and with the aid of an upper and a lower molds, the ball chain is formed by injection molding, after that, a ball chain is obtained by releasing the upper and lower molds. At this moment, the steel balls serving as a core are still in contact with the ball chain. And finally, it should try to make the steel balls lose contact with the ball chain (as disclosed in JP Pat. No. 552,217). Due to using steel balls as a core, plus a ball chain usually comprises tens of spacers, that is, tens of spacers all need to serve as mold cores, the conventional method of making ball chain requires too many molds, and the resultant production is too complicated.

After that, proposals were made to make ball chain by using separate upper mold and lower mold, and to separate the upper mold from the ball chain by force during mold releasing process. However, due to the interference strength between the mold and the ball chain is very great, it will lead to a server deformation of the chain during the mold releasing process (the finished product is lengthened). If increasing the interference of the steel balls with respect to the spacers and reducing the interference strength between the mold and the ball chain, it will adversely affect the rolling motion of the steel balls.

Therefore, the conventional ball chain manufacturing method has never been solved simultaneously in terms of manufacturing difficulties and spacing effect of the ball chain.

U.S. Pat. No. 5,062,208, as shown in FIGS. 3-5, discloses a method of molding a bearing separator by using an upper and a lower inserts 60 to form a circular space 71 in a separator 70, wherein each of the upper and lower inserts 60 is formed with a body 61 and a sloped guide surface 62. However, the inserts 60 are compulsively pulled along the axial (vertical) direction rather than in the inclined direction of the sloped guide surface 62, and the axial pulling of the inserts in a compulsive manner must be carried out after the separator 70 is formed and cooled down, otherwise causing deformation of the circular space 71. Hence, this method requires a relatively long molding time. Furthermore, since the body 61 is larger than the opening 72 of the space 71, the compulsive pulling of the inserts is likely to cause damage to the opening 72, resulting in a low yield rate. This method can only be used to mold the space 71 with a relatively shallow depth, and the formed separator 70 is unable to hold the ball for a long time and in an effective manner.

Another U.S. Pat. No. 4,362,687, as shown in FIG. 6, discloses a method and apparatus for molding of cages of cylindrical rolling elements, wherein two asymmetrical inserts 80A and 80B each comprises a cylindrical body 81A and 81B and a sloped parting surface 82A, 82B. After formation of the space 91 in the cage 90, the insert 80B is pulled at an angle and then removed at another angle, after that, the insert 80A is pulled at an angle and then removed at another angle. Such a method is free from the shortcoming of the compulsive pulling of the insert, however, the design of the asymmetrical inserts 80A and 80B and the sloped parting surface 82A, 82B only allows the inserts to be removed from the same side of the cage separately but not simultaneously, so the manufacturing speed is low. Further, since the inserts 80A and 80B must be removed at two different angles, the design of the molding structure is too complicated.

The present invention has arisen to mitigate and/or obviate the afore-described disadvantages.

### SUMMARY OF THE INVENTION

The primary objective of the present invention is to provide a method of making a ball chain, which can solve the difficulties in production and can improve the effect of spacers for separating the steel balls.

Since all points on a spherical surface are equidistant from the center of its sphere, the occurrence of interference can be prevented during mold release by releasing the half sphere along the normal direction of a plane passing through the center of the sphere.

The ball chain comprises a plurality of spacers, and a connecting member connected at either side of the respective spacers for connecting the spacers together in a string fashion, each two neighboring spacers define a space for holding a steel ball, and each spacer defines a concave in either side thereof for mating with the steel ball, so that a plurality of steel balls can freely roll within the space defined by the spacers without impacting one another. A method of making a ball chain in accordance with the present invention comprises the steps of:

forming an upper mold and a lower mold by injection molding process;

closing the upper mold and the lower mold, wherein the upper mold has an abutting configuration for mating with an upper surface of the connecting member and a protruding configuration for mating with the concave in one side of the spacer, and the lower mold has an abutting configuration for mating with a lower surface of the connecting member and a protruding configuration for mating with the concave in another side of the spacer;

injecting material into the cavity defined between the upper and lower molds, wherein the material can be plastic, rubber, or the other polymer; and

releasing the upper and lower molds along a direction inclined with respect to the connecting member.

Since all points on a spherical surface are equidistant from the center of its sphere, the occurrence of interference can be prevented during mold release by releasing the half sphere along the normal direction of a plane passing through the center of the sphere. And the two half molds (upper and lower molds) of the present invention are released along the normal direction of a plane passing through the center of the sphere, such mold releasing method can solve the difficulties in production and can improve the effect of spacer for separating the steel balls.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a front view of showing a ball chain;

FIG. 2 is a cross sectional view of the ball chain taken along the line A-A′ of FIG. 1;

FIG. 3 shows a cross section of a divided shaping mold;

FIG. 4 is similar to FIG. 3 but with the upper insert removed;

FIG. 5 is similar to FIG. 4 but with the lower insert removed;

FIG. 6 shows an apparatus for molding of cages of cylindrical rolling elements;

FIG. 7 is an illustrative view of showing a ball chain made by the method in accordance with the present invention, and an upper mold and a lower mold for making the ball chain;

FIG. 8 is an illustrative cross sectional view of showing that the upper and lower molds are closed together;

FIG. 9 is an illustrative cross sectional view of showing that the upper and lower molds are being released from each other;

FIG. 10 shows the relationship between the inclined angle θ1 and the wrap angle;

FIG. 11 shows a first embodiment of the present invention wherein the method of manufacturing a ball chain is applied to form ribs on the protruding configuration;

FIG. 12 shows a second embodiment of the present invention wherein the method of manufacturing a ball chain is applied to form ribs on the protruding configuration;

FIG. 13 shows another embodiment of the present invention in which protrusions are formed on the protruding configuration;

FIG. 14 is a cross sectional view taken along the line B-B′ of FIG. 13; and

FIG. 15 shows another embodiment of the present invention in which protrusions are formed on the protruding configuration.

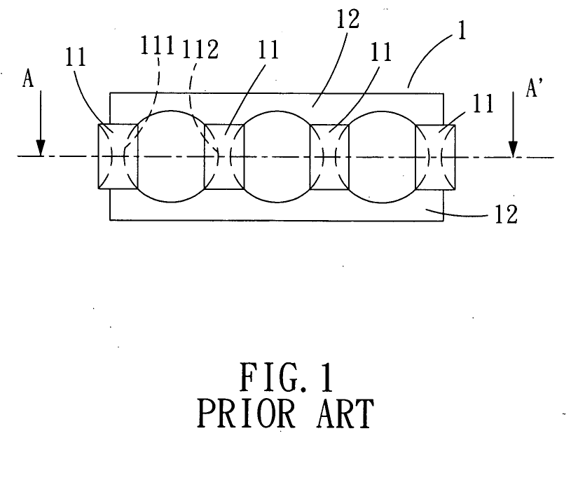

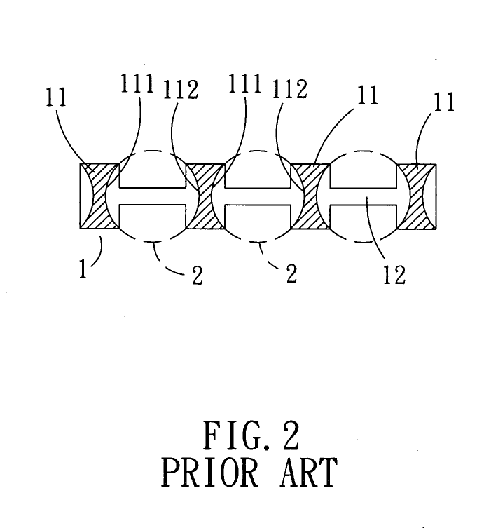

### DETAILED DESCRIPTION OF THE PREFERRED EMBODIMENTS

The foregoing, and additional objects, features and advantages of the present invention will become apparent from the following detailed description of preferred embodiments thereof, taken in conjunction with the accompanying drawings.

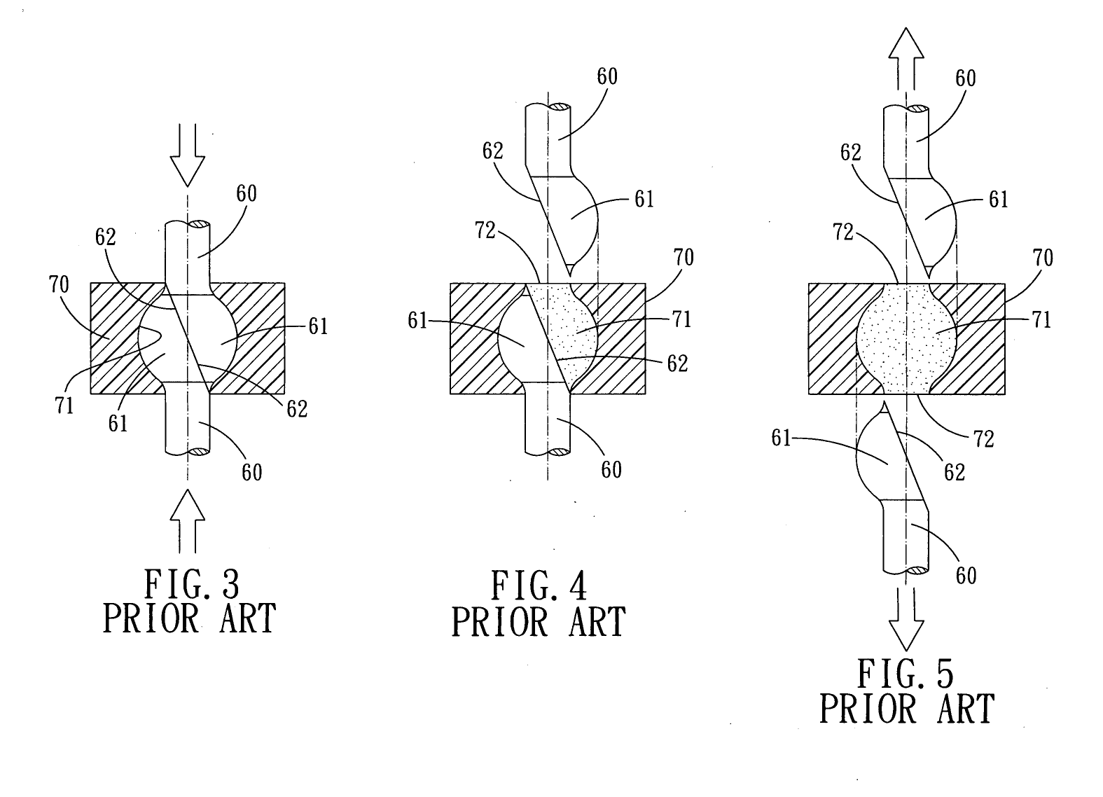

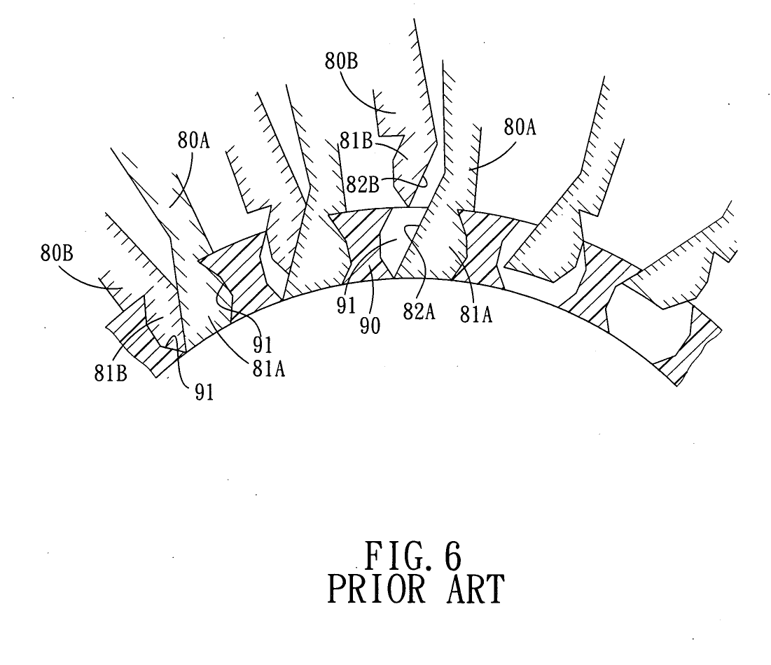

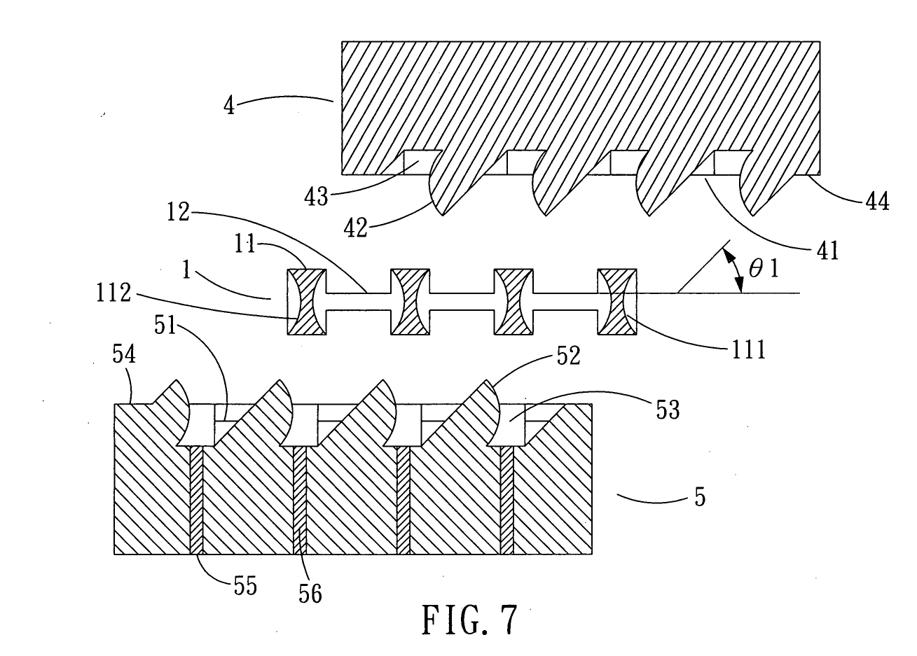

FIG. 7 is an illustrative view of showing a ball chain 1 made by the method in accordance with the present invention, and an upper mold 4 and a lower mold 5 for making the ball chain 1. The ball chain 1 in FIG. 3 comprises a plurality of spacers 11 (for easy description, only four spacer 11 are illustrated, but in fact, a ball chain may comprises tens of spacers 11), and a connecting member 12 connected at either side of the respective spacers 11 for connecting the spacers 11 together in a string fashion. Each two neighboring spacers 11 define a space for holding a steel ball (not shown), and each spacer 11 defines a concave 111, 112 in either side thereof for mating with the steel ball 2, so that a plurality of steel balls 2 can freely roll within the spaces defined by the spacers 11 without impacting each other. The concave 111 and 112 is of a spherical surface. The upper mold 4 has an abutting configuration 41 for mating with the configuration of the upper surface of the connecting member 12, and a protruding configuration 42 for mating with a concave 111 of the spacers 11. Likewise, the lower mold 5 has an abutting configuration 51 for mating with the configuration of the lower surface of the connecting member 12, and a protruding configuration 52 for mating with another concave 112 of the spacers 11. The spacer-configuration 43 of the upper mold 4 and the spacer-configuration 53 of the lower mold 5 in the drawing cooperate with each other to define a configuration of the outer diameter of the spacers 11. A land area 44 of the upper mold 4 and a land area 54 of the lower mold 5 will come into contact with each other when the two molds are closed. During mold release, the upper mold 4 is released from the lower mold 5 along an inclined angle θ1, thus preventing the occurrence of interference during mold release. A plurality of holes 55 are defined in the lower mold 5, and a plurality of lifting pins 56 are received in the holes 55 for separating the chain 1 from the lower mold 5.

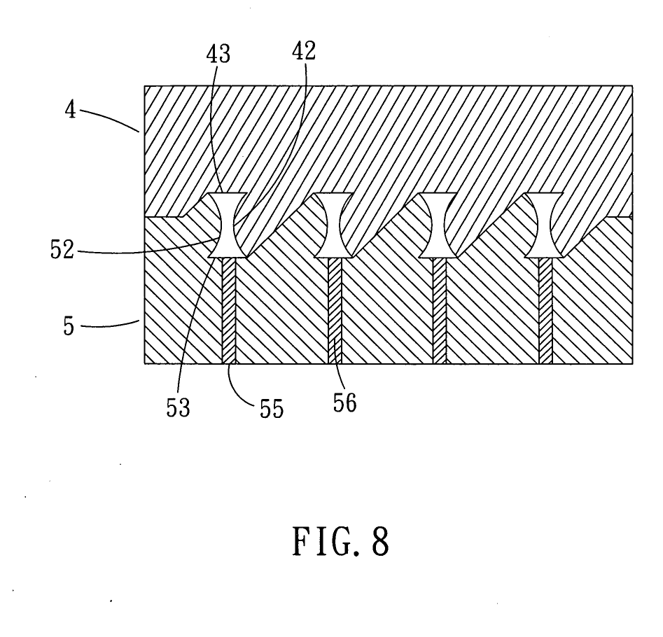

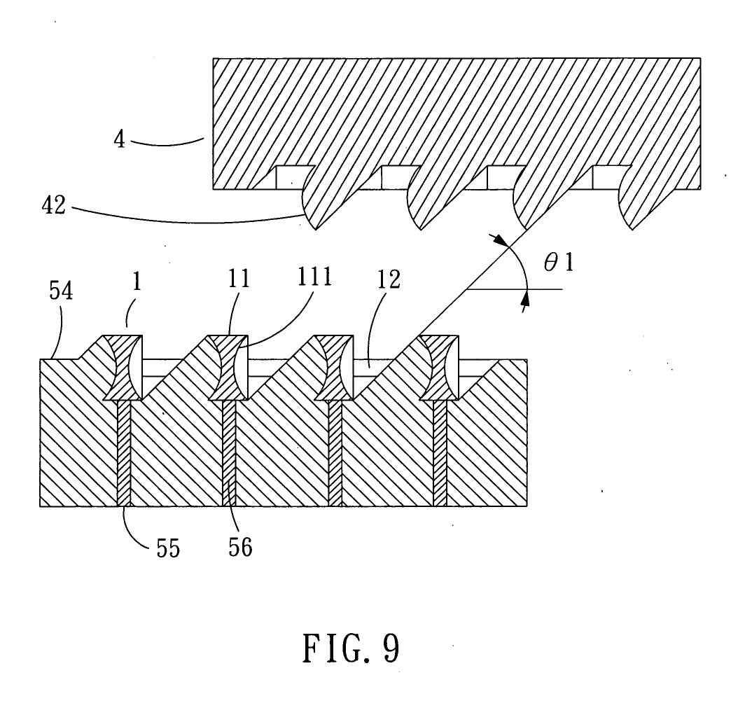

FIG. 8 is an illustrative cross sectional view of showing that the upper and lower molds are closed together. After the upper and lower molds 4 and 5 are closed, the spacer-configuration 43, the protruding configuration 42 of the upper mold 4 and the spacer-configuration 53, the protruding configuration 52 of the upper mold 5 will cooperate together to define a cavity having the shape of the spacer 11, for forming the spacers 11 of the ball chain 1. The ball chain in accordance with the method of the present invention is formed by injection molding process, and the required mold tool includes the upper mold 4 and the lower mold 5. In operation, the upper mold 4 and the lower mold 5 are closed (as shown in FIG. 8), and then material is injected into the cavity defined between the upper and lower molds 4 and 5. Finally, the upper and lower molds are released from each other in such a manner that the upper mold 4 and the lower mold 5 are released along a direction inclined with respect to the connecting member 12. FIG. 9 is an illustrative cross sectional view of showing that the upper and lower molds are being released from each other, wherein the upper mold 4 and the lower mold 5 are released along an inclined angle θ1 which is the angle of the horizontal line of the land areas 44, 45 with respect to the parting line of the two protruding configurations 42, 52, the inclined angle θ1 is between 30 and 60 degrees, so that the spacer 11 can wrap as large as 60 degrees portion of the steel ball. The inclined angle θ1 is optimally 45 degrees, and at this moment, the portion of the steel ball to be wrapped by the spacer 11 will be as great as 90 degrees. After releasing the upper and lower molds 4 and 5 from each other, the ball chain 1 can be released from the lower mold 5 by pushing the lifting pins 56 out of the holes 55, and thus a ball chain 1 is finished.

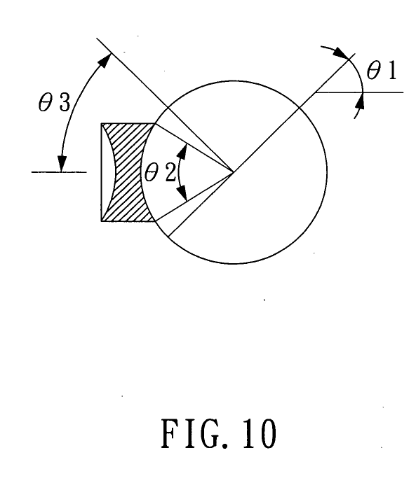

FIG. 10 shows the relationship between the inclined angle θ1 and the wrap angle (the wrap angle means the portion of the steel ball to be wrapped by the spacer, for example, the circumferential angle of steel ball is 360 degrees, and if the wrap angle is 60 degrees, that means one sixth portion of the steel ball will be wrapped by the spacer). When the protruding configuration 42 of the upper mold 4 shown in FIG. 9 is released along the inclined angle θ1, in order to prevent the protruding configuration 42 from interfering with the formed spacer 11, the wrap angle θ2 is the angle between the lines from the center of the concave 111 (or 112) of the spacer 11 to both ends of the concave 111 (or 112) and should be equal to or smaller than the greatest half angle θ3, and the greatest half angle θ3 equals to 90 degrees minus the inclined angle θ1. If the inclined angle θ1 is greater than 60 degrees, the greatest half angle θ3 will be 30 degrees, and the wrap angle θ2 will not be greater than 60 degrees. If the inclined angle θ1 is 45 degrees, the greatest half angle θ3 will be 45 degrees, and the wrap angle θ2 will be as great as 90 degrees. If the inclined angle θ1 is 60 degrees, approximately 60 degrees portion of each side of the steel ball will be confined, just like that two symmetrical sides of a hexagon are confined. Such arrangement already has a pretty good separating effect. If the inclined angle θ1 is 45 degrees, the wrap angle θ2 will be as great as 90 degrees, and approximately half periphery of the steel ball will be in contact with the spacer 11, and at this moment, the effect of confining the steel ball will be the best.

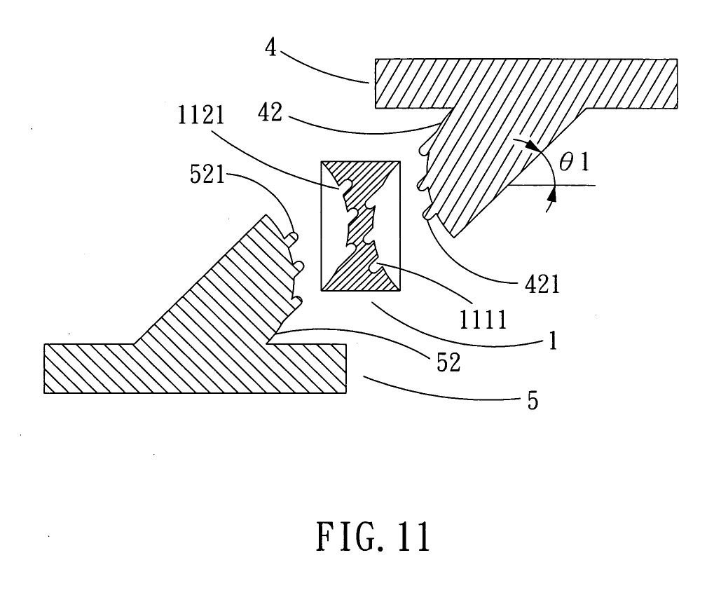

Still using the method of releasing mold along the inclined angle θ1, the protruding configurations 42 and 52 also can be defined with some ribs or protrusions. FIGS. 11-15 show some other embodiments of the present invention. As shown in FIG. 11, a plurality of ribs 421, 521 are formed on the protruding configurations 42 and 52, so that, after injection molding, a plurality of oil grooves 1111, 1121 will be formed in the concaves 111 and 112 of the spacer 11 for reserving a small amount of lubricant and reducing the resistance of the concaves 111 and 112 with respect to the steel balls. Since the forming direction of the ribs 421, 521 are the same as the inclined angle θ1, the occurrence of interference can be prevented during mold release. For easy illustration, the ribs 421, 521 in FIG. 11 extend horizontally, but in fact, they also can extend in longitudinal direction or in other directions.

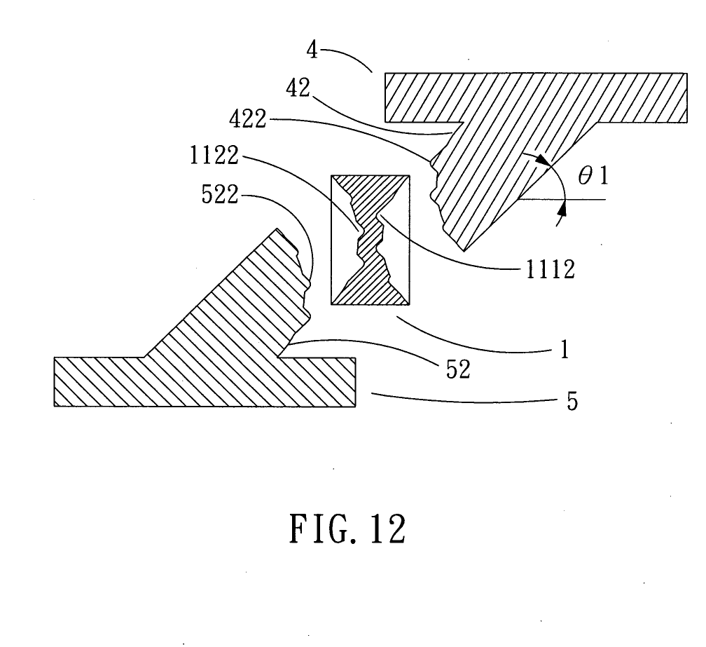

In the embodiment of FIG. 12, a plurality of ribs 422, 522 are formed on the protruding configurations 42 and 52, so that, after injection molding, a plurality of oil grooves 1112, 1122 will be formed in the concaves 111 and 112 of the spacer 11 for reserving a small amount of lubricant and reducing the resistance of the concaves 111 and 112 with respect to the steel balls. Since the forming direction of the ribs 421, 521 are the same as the inclined angle θ1, the occurrence of interference of the upper mold 4 with the upper mold 5 can be prevented during mold release.

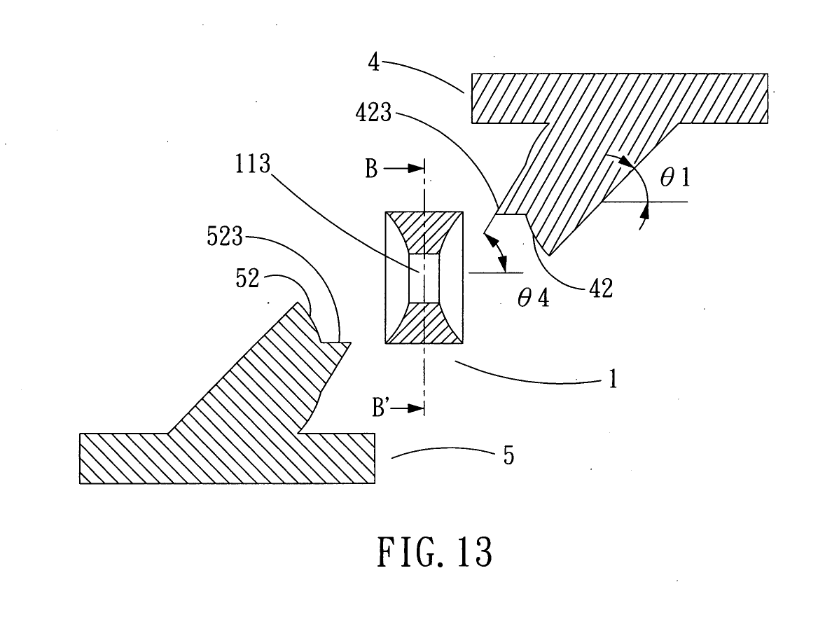

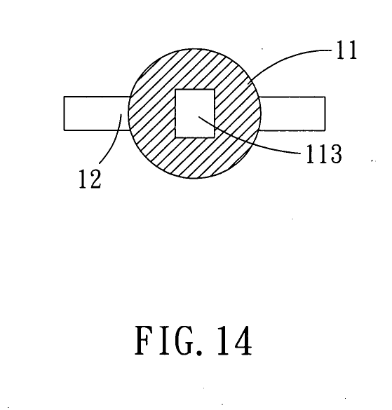

In addition, for facilitating the flow of lubricant through the respective steel balls, a through hole can be defined in each of the spacers 11. As shown in the embodiments of FIGS. 13 and 14, a protrusion 423 and 523 is formed on the protruding configurations 42 and 52. The protrusions 423 and 523 will contact each other to define a rectangular space when the upper and lower molds 4 and 5 are closed, thus a through square passage 113 will be formed in the spacer 11 after injection molding, and the passage 113 facilitates the flow of lubricant through the respective steel balls. For preventing the occurrence of interference between the protrusions 423 and 523 during mold release, the releasing angle θ4 should not be smaller than the inclined angle θ1. The releasing angle θ4 refers to an angle of the abutting surface of the two protrusions 423, 523 with respect to the connecting member 12.

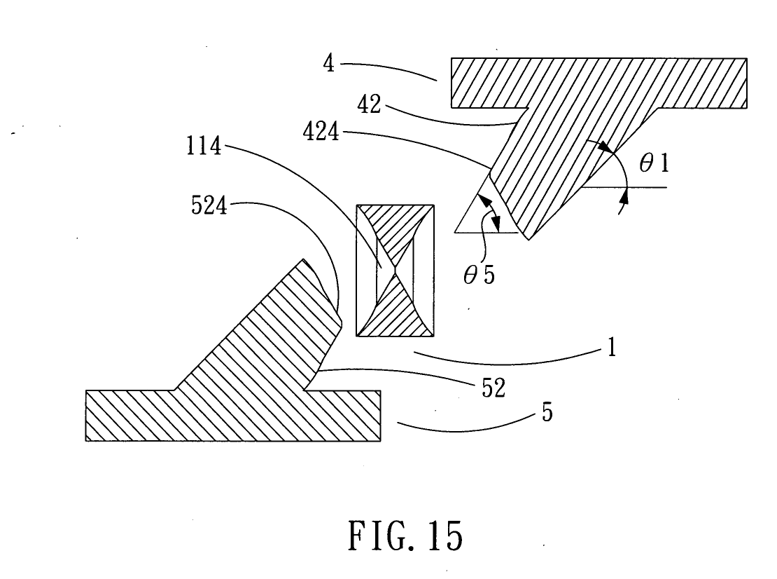

The embodiment shown in FIG. 15 is also designed to form a through passage in the spacer 11 for facilitating the flow of the lubricant through the steel balls. In FIG. 15, a protrusion 424 and 524 is formed on the protruding configurations 42 and 52, the protrusions 424 and 524 can be pyramid-shaped or conical-shaped. The protrusions 424 and 524 will contact each other to define a conical passage 114 when the upper and lower molds 4 and 5 are closed, and the passage 114 facilitates the flow of lubricant through the respective steel balls. For preventing the occurrence of interference of the protrusions 423 and 523 with the ball chain 1 during mold release, the half cone angle θ5 should not be greater than the inclined angle θ1.

To sum up, the manufacturing difficulties and spacing effect of the ball chain of the method for making a ball chain in accordance with the present invention are both improved through the structural and spatial design. Through the cooperation of the inclined angle θ1, the greatest half angle θ3, and the wrap angle θ2, and the concaves 111, 112 of the spacer 11, the upper and lower molds 4, 5 can be released smoothly without interference, so that the formed ball chain 1 has a better quality. Furthermore, the upper and lower molds 4, 5 are removed simultaneously at one time, so the molding time is short and the structure of the mold is simple.

While we have shown and described various embodiments in accordance with the present invention, it should be clear to those skilled in the art that further embodiments may be made without departing from the scope of the present invention.

What is claimed is:

1. A method of making a ball chain, wherein the ball chain comprises a plurality of spacers, and a connecting member connected at either side of the respective spacers for connecting the spacers together in a string fashion, each two neighboring spacers define a space for holding a steel ball, and each spacer defines a concave in either side thereof for mating with the steel ball, so that a plurality of steel balls can freely roll within the space defined by the spacers without impacting one another, the method comprising the steps of:
using injection molding process;
preparing an upper mold and a lower mold, the upper mold having a land area to abutted against a land area of the lower mold;
closing the upper mold and the lower mold, wherein the upper mold has an abutting configuration for mating with an upper surface of the connecting member and a protruding configuration for mating with the concave in one side of the spacer, and the lower mold has an abutting configuration for mating with a lower surface of the connecting member and a protruding configuration for mating with the concave in another side of the spacer;
injecting material into the cavity defined between the upper and lower molds; and
releasing the upper and lower molds along a direction inclined with respect to the connecting member;
wherein the molds are released along an inclined angle between 30 and 60 degrees, the inclined angle is an angle of a horizontal line of the land areas with respect to a parting line of the protruding configurations, a wrap angle is equal to or smaller than a greatest half angle, the wrap angle is an angle between lines from a center of the concave of the spacer to both ends of the concave, and the greatest half angle equals 90 degrees minus the inclined angle.

2. The method of making a ball chain as claimed in claim 1, wherein the inclined angle is 45 degrees.

3. The method of making a ball chain as claimed in claim 1, wherein the spacer provides an optimum effect of restricting the steel ball when the inclined angle is 45 degrees and the wrap angle is 90 degrees.

4. The method of making a ball chain as claimed in claim 1, wherein a plurality of ribs are formed on the protruding configuration of the upper mold so as to form a plurality of oil grooves in the concave of the ball chain after injection molding.

5. The method of making a ball chain as claimed in claim 1, wherein a plurality of ribs are formed on the protruding configuration of the lower mold so as to form a plurality of oil grooves in the concave of the ball chain after injection molding.

6. The method of making a ball chain as claimed in claim 4, wherein a forming direction of the ribs are the same as an inclined angle at which the molds being released, thus facilitating mold release.

7. The method of making a ball chain as claimed in claim 5, wherein a forming direction of the ribs are the same as the aforementioned inclined angle, thus facilitating mold release.

8. The method of making a ball chain as claimed in claim 1, wherein a protrusion is formed on each of the protruding configurations, and the two protrusions will contact each other after the upper and lower molds are closed, so as to form a through passage in the spacer.

9. The method of making a ball chain as claimed in claim 8, wherein the through passage is a conical passage.

10. The method of making a ball chain as claimed in claim 9, wherein the protrusion is conical shaped, and a half cone angle of the protrusion is greater than the aforementioned inclined angle.

11. The method of making a ball chain as claimed in claim 8, wherein an angle of an abutting surface of the two protrusions with respect to the connecting member is greater than the inclined angle.

12. The method of making a ball chain as claimed in claim 1I, wherein the two protrusions will cooperate with each other to define a rectangular space after the upper and lower molds are closed.

13. The method of making a ball chain as claimed in claim 1, wherein a plurality of holes are defined in the lower mold, and a plurality of lifting pins are received in the holes.

14. The method of making a ball chain as claimed in claim 1, wherein the concave is a spherical surface.

15. The method of making a ball chain as claimed in claim 2, wherein the spacer provides an optimum effect of restricting the steel ball when the inclined angle is 45 degrees and the wrap angle is 90 degrees.
